(19) United States
(12) Patent Application Publication
(10) Pub. No.: US 2015/0127755 A1
(43) Pub. Date: May 7, 2015

(54) METHOD AND APPARATUS FOR CHECKING STATUS OF MESSAGES IN ELECTRONIC DEVICE

(71) Applicant: Samsung Electronics Co., Ltd., Gyeonggi-do (KR)

(72) Inventors: Byoungtack ROH, Gyeonggi-do (KR); Soohyung KIM, Gyeonggi-do (KR); Huncheol OH, Seoul (KR)

(21) Appl. No.: 14/533,237

(22) Filed: Nov. 5, 2014

(30) Foreign Application Priority Data
Nov. 5, 2013 (KR) 10-2013-0133371

(51) Int. Cl. H04L 12/58

(52) U.S. Cl. CPC H04L 51/24
USPC 709/206

(57) ABSTRACT

A method and apparatus for checking the status of sent and received messages in an electronic device. The method may include: setting, when a message is sent, the reception confirmation state of the sent message to “unread”; and displaying a notification window in at least one of a status display window of the electronic device, a status display window of an application program and a usage history window of the electronic device so as to present at least one sent message whose reception confirmation state is set to “unread” as being unread. The method and apparatus is operable with or without a message server between the electronic device and a counterpart device associated with the message.

### CLAIM OF PRIORITY

This application claims the benefit of priority under 35 U.S.C. §119(a) from a Korean patent application filed on Nov. 5, 2013 in the Korean Intellectual Property Office and assigned Serial No. 10-2013-0133371, the entire disclosure of which is hereby incorporated by reference in its entirety.

### BACKGROUND

1. Field of the Disclosure

The present disclosure relates to a method and apparatus for identifying the status of sent and received messages in an electronic device.

2. Description of the Related Art

An electronic device supporting communication functions may send and receive messages to and from another electronic device. Here, the exchanged messages that are sent and received may be an email message, a Short Message Service (SMS) message supporting short text, a Multimedia Messaging Service (MMS) message supporting long text, and an interactive message such as an instant message. Various applications installed in the electronic device, such as KakaoTalk and ChatON, may support interactive message transmission and reception through instant messaging.

Such instant messaging applications may be run on various types of electronic devices such as personal computers using the Internet and smartphones using mobile communication networks. Electronic devices may exchange messages through wired/wireless communication protocols such as Bluetooth, Wi-Fi and Device-to-Device (D2D) without traversing the base station or core network.

In the case of interactive messaging, it is a common practice to notify the user, among messages received from counterpart users, messages that are unread by the user. However, there is no generally accepted scheme that enables the user to readily check whether a message sent by the user is read by the counterpart user.

To check whether a message sent by the user is read by the counterpart user, the user may have to execute the corresponding application and view a particular dialog window. In other words, to identify the status of sent or received messages, the user is inconvenienced when having to execute a corresponding application and navigate to a window displaying status information on sent or received messages.

In addition, whereas a scheme that displays information on the status (read or unread) of received messages is provided in most cases, a scheme that enables the user to easily check the status of a message sent to a counterpart user is not generally provided, which causes a great deal of inconvenience to the user.

### SUMMARY

Aspects of the present disclosure are to address at least the above mentioned problems and/or disadvantages and to provide at least the advantages described below. Accordingly, an aspect of the present disclosure is to provide a method and apparatus for an electronic device that enable the user to readily identify whether or not a message sent to a counterpart user is read by the counterpart user.

Another aspect of the present disclosure is to provide a method and apparatus for an electronic device that enable the user to identify whether an instant message sent to a counterpart user is read by the counterpart user without initiation of the corresponding application.

In accordance with an aspect of the present disclosure, a method for checking the status of a message in an electronic device is provided. The method may include, for example: setting, when a message is sent, the reception confirmation state of the sent message to “unread”; and displaying a notification window (i.e. area) in at least one of a status display window of the electronic device, a status display window of an application program and a usage history window of the electronic device so as to present at least one sent message whose reception confirmation state is set to “unread” as being unread.

In accordance with another aspect of the present disclosure, an electronic device supporting message status checking is provided as an apparatus. The electronic device may include: a communication module configured to communicate with another electronic device; a display module configured to display a message being composed and to notify a sent message in the “unread” state; a memory module configured to store sent messages, received messages, and communication histories; a user input module configured to generate an input signal corresponding to user input; and a processor to control a process of setting, when a message is sent, the reception confirmation state of the sent message to “unread”, and displaying a notification window in at least one window displayed on the display module among a status display window of the electronic device, a status display window of an application program and a usage history window of the electronic device so as to present at least one sent message whose reception confirmation state is set to “unread” as being unread.

In a feature of the present disclosure, when instant messages are exchanged in real time, the user of an electronic device may readily identify whether an instant message sent to a counterpart user is read by the counterpart user. As the number of navigation levels or depths needed to identify the status of a message sent to a counterpart user is decreased, usability of the messaging function can be enhanced.

### BRIEF DESCRIPTION OF THE DRAWINGS

The above and other aspects, features, and advantages of certain embodiments of the present disclosure will become more apparent to a person of ordinary skill in the art from the following detailed description taken in conjunction with the accompanying drawings, in which:

FIG. 1 is a block diagram illustrating a configuration of an electronic device according to an embodiment of the present disclosure;

FIG. 2 is a block diagram illustrating a configuration of hardware 200 according to an embodiment of the present disclosure;

FIG. 3 is a block diagram illustrating a configuration of a programming module 300 according to an embodiment of the present disclosure;

FIG. 4A and FIG. 4B illustrate the exchange of messages between electronic devices according to an embodiment of the present disclosure;

FIG. 5 is a flowchart illustrating an example of an operational procedure for sending and receiving messages in an electronic device according to an embodiment of the present disclosure;

FIG. 6 is a flowchart illustrating an example of an operational procedure for handling the status of a sent message according to an embodiment of the present disclosure; and

FIG. 7A, FIG. 7B and FIG. 7C are screen representations illustrating the display of messages unread by a counterpart user among messages sent by the electronic device according to various embodiments of the present disclosure.

### DETAILED DESCRIPTION

Hereinafter, various embodiments of the present disclosure are described in detail with reference to the accompanying drawings. The following description includes various specific details to assist a person of ordinary skill in the art with that understanding, but these specific details are to be regarded as merely exemplary and do not limit or define the appended claims. Accordingly, a person of ordinary skill in the art will recognize that various changes and modifications of the embodiments described herein can be made without departing from the scope and spirit of the present disclosure as defined by the claims and their equivalents. The same reference symbols are used throughout the drawings to refer to the same or like parts.

The terms and words used in the following description and claims are not limited to the bibliographical meanings, but, are merely used by the inventor to enable a clear and consistent understanding of the present disclosure to a person of ordinary skill.

Accordingly, it should be apparent to those skilled in the art that the following description of various embodiments of the present disclosure is provided for illustration purpose only and not for the purpose of limiting the present disclosure, as defined by the appended claims and their equivalents.

It is to be understood that the singular forms “a,” “an,” and “the” include plural references unless the context clearly dictates otherwise. Thus, for example, reference to “a component surface” includes reference to one or more of such surfaces.

The expressions such as “include” and “may include” which may be used in the present disclosure denote the presence of the disclosed functions, operations, and constituent elements and do not limit one or more additional functions, operations, and constituent elements.

In the present disclosure, the terms such as “include” and/or “have” may be construed to denote a certain characteristic, number, step, operation, constituent element, component or a combination thereof, but may not be construed to exclude the existence of or a possibility of addition of one or more other characteristics, numbers, steps, operations, constituent elements, components or combinations thereof.

Furthermore, in the present disclosure, the expression “and/or” includes any and all combinations of the associated listed words. For example, the expression “A and/or B” may include A, may include B, or may include both A and B.

In the present disclosure, expressions including ordinal numbers, such as “first” and “second,” etc., may modify various elements. However, such elements are not limited by the above expressions. For example, the above expressions do not limit the sequence and/or importance of the elements. The above expressions are used merely for the purpose to distinguish an element from the other elements. For example, a first user device and a second user device indicate different user devices although both of them are user devices. For example, a first element could be termed a second element, and similarly, a second element could be also termed a first element without departing from the scope of the present disclosure.

In the case where a component is referred to as being “connected” or “accessed” to other component, it should be understood that not only the component is directly connected or accessed to the other component, but also there may exist another component between them. Meanwhile, in the case where a component is referred to as being “directly connected” or “directly accessed” to other component, it should be understood that there is no component there between. The terms used in the present disclosure are only used to describe specific various embodiments and are not intended to limit the present disclosure. As used herein, the singular forms are intended to include the plural forms as well, unless the context clearly indicates otherwise.

An electronic device according to the present disclosure may be a device including a communication function. For example, the device corresponds to a combination of at least one of a smartphone, a tablet Personal Computer (PC), a mobile phone, a video phone, an e-book reader, a desktop PC, a laptop PC, a netbook computer, a Personal Digital Assistant (PDA), a Portable Multimedia Player (PMP), a digital audio player, a mobile medical device, an electronic bracelet, an electronic necklace, an electronic accessory, a camera, a wearable device, an electronic clock, a wrist watch, home appliances (for example, an air-conditioner, vacuum, an oven, a microwave, a washing machine, an air cleaner, and the like), an artificial intelligence robot, a TeleVision (TV), a Digital Video Disk (DVD) player, an audio device, various medical devices (for example, Magnetic Resonance Angiography (MRA), Magnetic Resonance Imaging (MRI), Computed Tomography (CT), a scanning machine, a ultrasonic wave device, or the like), a navigation device, a Global Positioning System (GPS) receiver, an Event Data Recorder (EDR), a Flight Data Recorder (FDR), a set-top box, a TV box (for example, Samsung HomeSync™, Apple TV™, or Google TV™), an electronic dictionary, vehicle infotainment device, an electronic equipment for a ship (for example, navigation equipment for a ship, gyrocompass, or the like), avionics, a security device, electronic clothes, an electronic key, a camcorder, game consoles, a Head-Mounted Display (HMD), a flat panel display device, an electronic frame, an electronic album, furniture or a portion of a building/structure that includes a communication function, an electronic board, an electronic signature receiving device, a projector, and the like. The electronic device according to the present disclosure is not limited to the aforementioned devices.

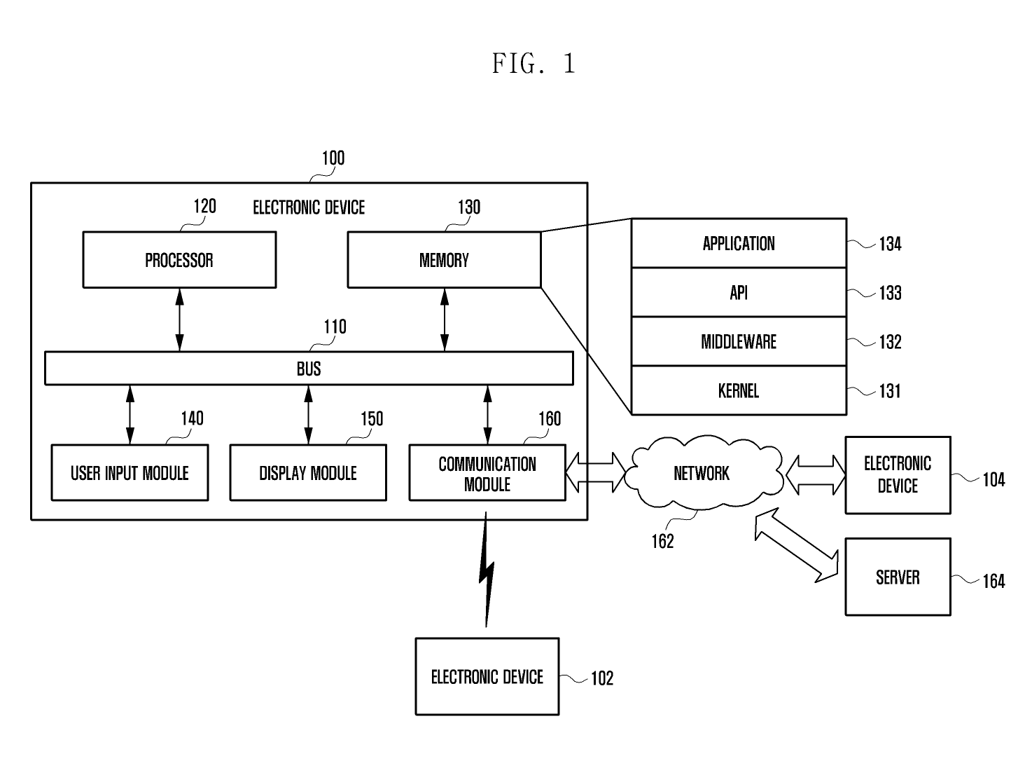

FIG. 1 is a block diagram illustrating a configuration of an electronic device according to an embodiment of the present disclosure.

Referring now to FIG. 1, the electronic device 100 may include a bus 110, a processor 120, a memory 130, a user input module 140, a display module 150, a communication module 160, and other similar and/or suitable components.

The bus 110 provides various communication paths and may be a circuit which interconnects the above-described elements and delivers a communication (e.g., a control message) between the above-described elements.

The processor 120, which may be referred to as a microprocessor, controller or control unit, comprises hardware such as integrated circuitry configured for operation and may receive commands from the above-described other elements (e.g., the memory 130, the user input module 140, the display module 150, the communication module 160, etc.) through the bus 110, may interpret the received commands, and may execute calculation or data processing according to the interpreted commands.

The memory 130, which comprises a non-transitory memory that may be one of various constructions, may store commands or data received from the processor 120 or other elements (e.g., the user input module 140, the display module 150, the communication module 160, etc.) or generated by the processor 120 or the other elements. The memory 130 may include programming modules, such as a kernel 131, middleware 132, an Application Programming Interface (API) 133, an application 134, and the like. Each of the above-described programming modules may be implemented in software associated with hardware, firmware, hardware, or a combination of two or more thereof.

The kernel 131 may control or manage system resources (e.g., the bus 110, the processor 120, the memory 130, etc.) used to execute operations or functions implemented by other programming modules (e.g., the middleware 132, the API 133, and the application 134). Also, the kernel 131 may provide an interface capable of accessing and controlling or managing the individual elements of the electronic device 100 by using the middleware 132, the API 133, or the application 134.

The middleware 132 may serve as a communication path between the API 133 or the application 134 and the kernel 131 in such a manner that the API 133 or the application 134 communicates with the kernel 131 and exchanges data therewith. Also, in relation to work requests received from one or more applications 134 and/or the middleware 132, for example, may perform load balancing of the work requests by using a method of assigning a priority, in which system resources (e.g., the bus 110, the processor 120, the memory 130, etc.) of the electronic device 100 can be used, to at least one of the one or more applications 134.

With continued reference to FIG. 1, the API 133 is an interface through which the application 134 is capable of controlling a function provided by the kernel 131 or the middleware 132, and may include, for example, at least one interface or function for file control, window control, image processing, character control, or the like.

The user input module 140, for example, may receive a command or data as input from a user, and may deliver the received command or data to the processor 120 or the memory the 130 through the bus 110. The display module 150 may display a video, an image, data, or the like to the user.

The communication module 160 may connect communication between another electronic device 102 and the electronic device 100. The communication module 160 may support a predetermined short-range communication protocol (e.g. Wi-Fi, BlueTooth (BT), and Near Field Communication (NFC)), or a predetermined network communication 162 (e.g., the Internet, a Local Area Network (LAN), a Wide Area Network (WAN), a telecommunication network, a cellular network, a satellite network, a Plain Old Telephone Service (POTS), or the like). Each of the electronic devices 102 and 104 may be a device which is identical (e.g., of an identical type) to or different (e.g., of a different type) from the electronic device 100. Further, the communication module 160 may connect communication between a server 164 and the electronic device 100 via the network 162.

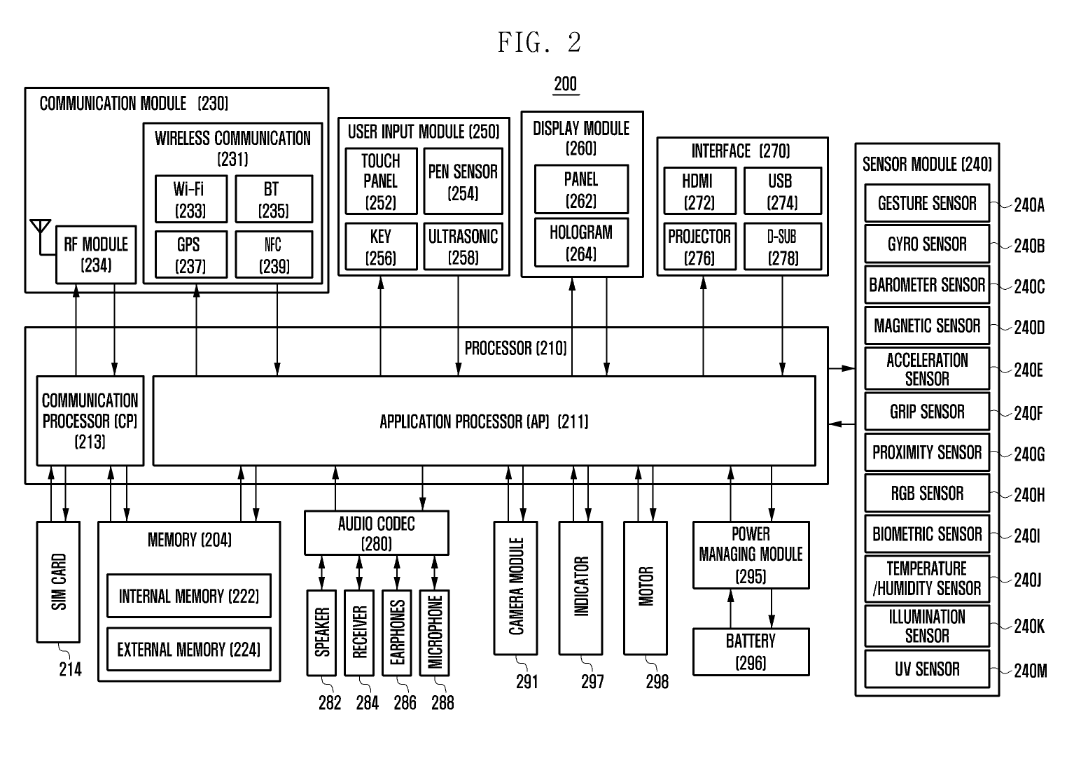

FIG. 2 is a block diagram illustrating a configuration of hardware 200 according to an embodiment of the present disclosure.

The hardware 200 may be, for example, the electronic device 100 illustrated in FIG. 1.

Referring to FIG. 2, the hardware 200 may include one or more processors 210, a Subscriber Identification Module (SIM) card 214, a memory 220, a communication module 230, a sensor module 240, a user input module 250, a display module 260, an interface 270, an audio coder/decoder (codec) 280, a camera module 291, a power management module 295, a battery 296, an indicator 297, a motor 298 and any other similar and/or suitable components.

The processor 210 (e.g., the processor 120) may include one or more Application Processors (APs) 211, or one or more Communication Processors (CPs) 213. The processor 210 may be, for example, the processor 120 illustrated in FIG. 1. The AP 211 and the CP 213 are illustrated as being included in the processor 210 in FIG. 2, but may be included in different Integrated Circuit (IC) packages, respectively. According to an embodiment of the present disclosure, the AP 211 and the CP 213 may be included in one IC package.

The AP 211 may execute an Operating System (OS) or an application program, and thereby may control multiple hardware or software elements connected to the AP 211 and may perform processing of and arithmetic operations on various data including multimedia data. The AP 211 may be implemented by, for example, a System on Chip (SoC). According to an embodiment of the present disclosure, the processor 210 may further include a Graphical Processing Unit (GPU) (not illustrated).

The CP 213 may manage a data line and may convert a communication protocol in the case of communication between the electronic device (e.g., the electronic device 100) including the hardware 200 and different electronic devices connected to the electronic device through the network. The CP 213 may be implemented by, for example, a SoC. According to an embodiment of the present disclosure, the CP 213 may perform at least some of the multimedia control functions. The CP 213, for example, may distinguish and authenticate a terminal in a communication network by using a subscriber identification module (e.g., the SIM card 214). Also, the CP 213 may provide the user with services, such as a voice telephony call, a video telephony call, a text message, packet data, and the like.

Further, the CP 213 may control the transmission and reception of data by the communication module 230. As shown in FIG. 2, the elements such as the CP 213, the power management module 295, the memory 220, and the like are illustrated as elements separate from the AP 211. However, according to an embodiment of the present disclosure, the AP 211 may include at least some (e.g., the CP 213) of the above-described elements.

According to an embodiment of the present disclosure, the AP 211 or the CP 213 may load to a volatile memory, a command or data received from at least one of a non-volatile memory and other elements connected to each of the AP 211 and the CP 213, and may process the loaded command or data. Also, the AP 211 or the CP 213 may store, in a non-volatile memory, data received from, or generated by, at least one of the other elements.

The SIM card 214 may be a card implementing a subscriber identification module, and may be inserted into a slot formed in a particular portion of the electronic device 100. The SIM card 214 may include unique identification information (e.g., Integrated Circuit Card IDentifier (ICCID)) or subscriber information (e.g., International Mobile Subscriber Identity (IMSI)). While the term SIM card is being used, an artisan understands and appreciates that the term would include, for example, a Micro-Sim, a nano-Sim, R-UIM, USIM, just to name some non-limiting possibilities.

The memory 220 may include an internal memory 222 and an external memory 224. The memory 220 may be, for example, the memory 130 illustrated in FIG. 1. The internal memory 222 may include, for example, at least one of a volatile memory (e.g., a Dynamic RAM (DRAM), a Static RAM (SRAM), a Synchronous Dynamic RAM (SDRAM), etc.), and a non-volatile memory (e.g., a One Time Programmable ROM (OTPROM), a Programmable ROM (PROM), an Erasable and Programmable ROM (EPROM), an Electrically Erasable and Programmable ROM (EEPROM), a mask ROM, a flash ROM, a Not AND (NAND) flash memory, a Not OR (NOR) flash memory, etc.). According to an embodiment of the present disclosure, the internal memory 222 may be in the form of a Solid State Drive (SSD). The external memory 224 may further include a flash drive, for example, a Compact Flash (CF), a Secure Digital (SD), a Micro-Secure Digital (Micro-SD), a Mini-Secure Digital (Mini-SD), an extreme Digital (xD), a memory stick, or the like. It should be appreciated that the memory is non-transitory in nature.

The communication module 230 may include a wireless communication module 231 or a Radio Frequency (RF) module 234. The communication module 230 may be, for example, the communication module 160 illustrated in FIG. 1. The wireless communication module 231 may include, for example, a Wi-Fi part 233, a BT part 235, a GPS part 237, or a NFC part 239. For example, the wireless communication module 231 may provide a wireless communication function by using a radio frequency. Additionally or alternatively, the wireless communication module 231 may include a network interface (e.g., a LAN card), a modulator/demodulator (modem), or the like for connecting the hardware 200 to a network (e.g., the Internet, a LAN, a WAN, a telecommunication network, a cellular network, a satellite network, a POTS, or the like).

The RF module 234 may be used for transmission and reception of data, for example, transmission and reception of RF signals or called electronic signals. Although not illustrated, the RF unit 234 may include, for example, a transceiver, a Power Amplifier Module (PAM), a frequency filter, a Low Noise Amplifier (LNA), or the like. Also, the RF module 234 may further include a component for transmitting and receiving electromagnetic waves in a free space in a wireless communication, for example, a conductor, a conductive wire, or the like.

The sensor module 240 may include, for example, at least one of a gesture sensor 240A, a gyro sensor 240B, an atmospheric pressure sensor 240C, a magnetic sensor 240D, an acceleration sensor 240E, a grip sensor 240F, a proximity sensor 240G, a Red, Green and Blue (RGB) sensor 240H, a biometric sensor 240I, a temperature/humidity sensor 240J, an illuminance sensor 240K, and a Ultra Violet (UV) sensor 240M, or even an IR sensor. The sensor module 240 may measure a physical quantity or may sense an operating state of the electronic device 100, and may convert the measured or sensed information to an electrical signal. Additionally/alternatively, the sensor module 240 may include, for example, an E-nose sensor (not illustrated), an ElectroMyoGraphy (EMG) sensor (not illustrated), an ElectroEncephaloGram (EEG) sensor (not illustrated), an ElectroCardioGram (ECG) sensor (not illustrated), a fingerprint sensor (not illustrated), and the like. Additionally or alternatively, the sensor module 240 may include, for example, an E-nose sensor (not illustrated), an EMG sensor (not illustrated), an EEG sensor (not illustrated), an ECG sensor (not illustrated), a fingerprint sensor, and the like. The sensor module 240 may further include a control circuit (not illustrated) for controlling one or more sensors included therein.

The user input module 250 may include a touch panel 252, a pen sensor 254 (e.g., a digital pen sensor), keys 256, and an ultrasonic input unit 258. The user input module 250 may be, for example, the user input module 140 illustrated in FIG. 1. The touch panel 252 may recognize a touch input in at least one of, for example, a capacitive scheme, a resistive scheme, an infrared scheme, and an acoustic wave scheme. Also, the touch panel 252 may further include a controller (not illustrated). In the capacitive type, the touch panel 252 is capable of recognizing proximity as well as a direct touch. The touch panel 252 may further include a tactile layer (not illustrated). In this event, the touch panel 252 may provide a tactile response to the user.

The pen sensor 254 (e.g., a digital pen sensor), for example, may be implemented by using a method identical or similar to a method of receiving a touch input from the user, or by using a separate sheet for recognition. For example, a key pad or a touch key may be used as the keys 256. The ultrasonic input unit 258 enables the terminal to sense a sound wave by using a microphone (e.g., a microphone 288) of the terminal through a pen generating an ultrasonic signal, and to identify data. The ultrasonic input unit 258 is capable of wireless recognition. According to an embodiment of the present disclosure, the hardware 200 may receive a user input from an external device (e.g., a network, a computer, or a server), which is connected to the communication module 230, through the communication module 230.

With continued reference to FIG. 2, the display module 260 may include, for example, a panel 262 or a hologram 264. The display module 260 may be, for example, the display module 150 illustrated in FIG. 1. The panel 262 may be, for example, a Liquid Crystal Display (LCD) and an Active Matrix Organic Light Emitting Diode (AM-OLED) display, and the like. The panel 262 may be implemented so as to be, for example, flexible, transparent, or wearable. The panel 262 may include the touch panel 252 and one module. The hologram 264 may display a three-dimensional image in the air by using an interference of light. According to an embodiment of the present disclosure, the display module 260 may further include a control circuit for controlling the panel 262 or the hologram 264.

The interface 270 may include, for example, a High-Definition Multimedia Interface (HDMI) 272, a Universal Serial Bus (USB) 274, a projector 276, and a D-subminiature (D-sub) 278. Additionally or alternatively, the interface 270 may include, for example, SD/Multi-Media Card (MMC) (not illustrated) or Infrared Data Association (IrDA) (not illustrated).

The audio codec 280 may bidirectionally convert between a voice and an electrical signal. The audio codec 280 may convert voice information, which is input to or output from the audio codec 280, through, for example, a speaker 282, a receiver 284, an earphone 286, the microphone 288 or the like.

The camera module 291 may capture an image and a moving image. According to an embodiment, the camera module 291 may include one or more image sensors (e.g., a front lens or a back lens), an Image Signal Processor (ISP) (not illustrated), and a flash LED (not illustrated).

The power management module 295 may manage power of the hardware 200. Although not illustrated, the power management module 295 may also include, for example, a Power Management Integrated Circuit (PMIC), a charger Integrated Circuit (IC), or a battery fuel gauge.

The PMIC may be mounted to, for example, an IC or a SoC semiconductor. Charging methods may be classified into a wired charging method and a wireless charging method. The charger IC may charge a battery, and may prevent an overvoltage or an overcurrent from a charger to the battery. According to an embodiment of the present disclosure, the charger IC may include a charger IC for at least one of the wired charging method and the wireless charging method. Examples of the wireless charging method may include a magnetic resonance method, a magnetic induction method, an electromagnetic method, and the like, just to name some non-limiting possibilities. Additional circuits (e.g., a coil loop, a resonance circuit, a rectifier, etc.) for wireless charging may be added in order to perform the wireless charging.

The battery gauge may measure, for example, a residual quantity of the battery 296, or a voltage, a current or a temperature during the charging. The battery 296 may supply power by generating electricity, and may be, for example, a rechargeable battery.

The indicator 297 may indicate particular states of the hardware 200 or a part (e.g., the AP 211) of the hardware 200, for example, a booting state, a message state, a charging state and the like. The motor 298 may convert an electrical signal into a mechanical vibration. The processor 210 may control the sensor module 240.

Although not illustrated, the hardware 200 may include a processing unit (e.g., a GPU) for supporting a module TV. The processing unit for supporting a module TV may process media data according to standards such as, for example, Digital Multimedia Broadcasting (DMB), Digital Video Broadcasting (DVB), media flow, and the like. Each of the above-described elements of the hardware 200 according to an embodiment of the present disclosure may include one or more components, and the name of the relevant element may change depending on the type of electronic device. The hardware 200 according to an embodiment of the present disclosure may include at least one of the above-described elements. Some of the above-described elements may be omitted from the hardware 200, or the hardware 200 may further include additional elements. Also, some of the elements of the hardware 200 according to an embodiment of the present disclosure may be combined into one entity, which may perform functions identical to those of the relevant elements before the combination.

The term “module” used in the present disclosure may refer to, for example, a unit including combinations of hardware with software and/or firmware. The “module” may be interchangeable with a term, such as “unit,” “logic,” “logical block,” “component,” “circuit,” “integrated circuit” or the like. The “module” may be a minimum unit of a component formed as one body or a part thereof. The “module” may be a minimum unit for performing one or more functions or a part thereof. The “module” may be implemented mechanically or electronically. For example, the “module” according to an embodiment of the present disclosure may include at least one of an Application-Specific Integrated Circuit (ASIC) chip, a Field-Programmable Gate Array (FPGA), and a programmable-logic device for performing certain operations which have been known or are to be developed in the future.

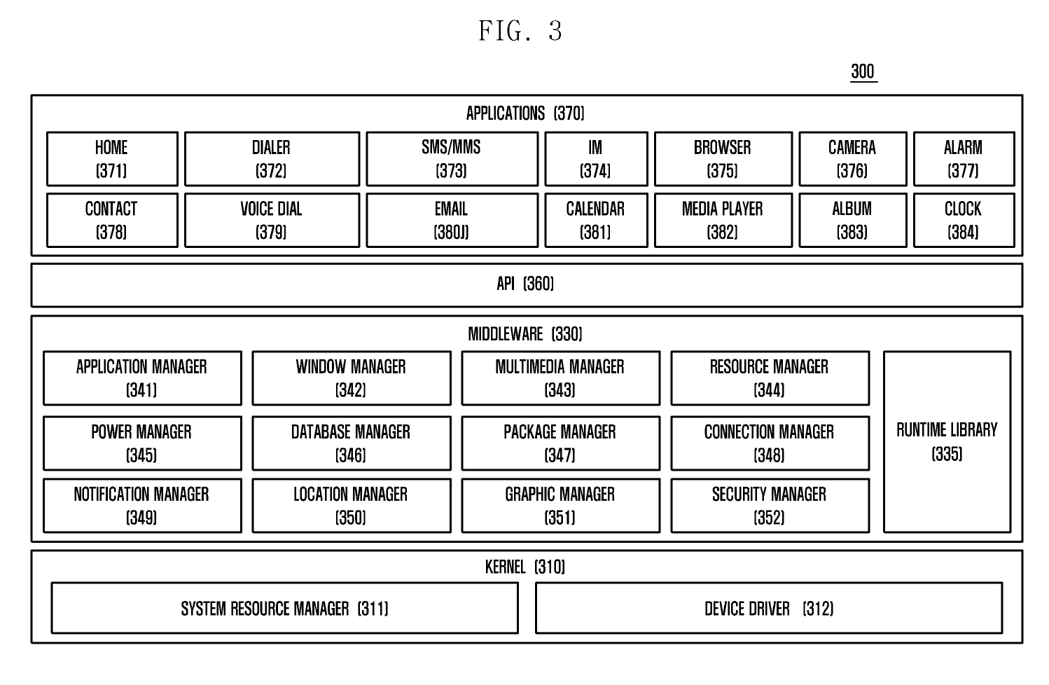

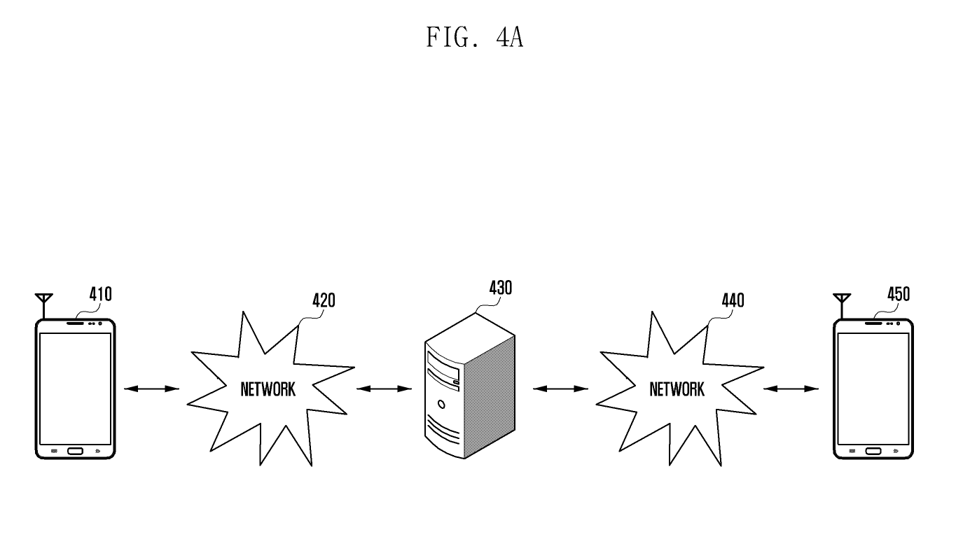

FIG. 3 is a block diagram illustrating a configuration of a programming module 300 according to another embodiment of the present disclosure.

The programming module 300 may be included (or stored) in the electronic device 100 (e.g., the memory 130) or may be included (or stored) in the electronic device 200 (e.g., the memory 230) illustrated in FIG. 1. At least a part of the programming module 300 may be implemented in software or firmware that configures hardware, or a combination of two or more thereof. The programming module 300 may be implemented in hardware (e.g., the hardware 200), and may include an OS controlling resources related to an electronic device (e.g., the electronic device 100) and/or various applications (e.g., an application 370) executed in the OS. For example, the OS may be Android, iOS, Windows, Symbian, Tizen, Bada, and the like.

Referring now to FIG. 3, the programming module 300 may include a kernel 310, a middleware 330, an API 360, and/or the application 370.

The kernel 310 (e.g., the kernel 131) may include a system resource manager 311 and/or a device driver 312. The system resource manager 311 may include, for example, a process manager (not illustrated), a memory manager (not illustrated), and a file system manager (not illustrated). The system resource manager 311 may perform the control, allocation, recovery, and/or the like of system resources. The device driver 312 may include, for example, a display driver (not illustrated), a camera driver (not illustrated), a Bluetooth driver (not illustrated), a shared memory driver (not illustrated), a USB driver (not illustrated), a keypad driver (not illustrated), a Wi-Fi driver (not illustrated), and/or an audio driver (not illustrated). Also, according to an embodiment of the present disclosure, the device driver 312 may include an Inter-Process Communication (IPC) driver (not illustrated).

The middleware 330 may include multiple modules previously implemented so as to provide a function used in common by the applications 370. Also, the middleware 330 may provide a function to the applications 370 through the API 360 in order to enable the applications 370 to efficiently use limited system resources within the electronic device. For example, as illustrated in FIG. 3, the middleware 330 (e.g., the middleware 132) may include at least one of a runtime library 335, an application manager 341, a window manager 342, a multimedia manager 343, a resource manager 344, a power manager 345, a database manager 346, a package manager 347, a connectivity manager 348, a notification manager 349, a location manager 350, a graphic manager 351, a security manager 352, and any other suitable and/or similar manager.

The runtime library 335 may include, for example, a library module used by a compiler, in order to add a new function by using a programming language during the execution of the application 370. According to an embodiment of the present disclosure, the runtime library 335 may perform functions which are related to input and output, the management of a memory, an arithmetic function, and/or the like.

The application manager 341 may manage, for example, a life cycle of at least one of the applications 370. The window manager 342 may manage GUI resources used on the screen. The multimedia manager 343 may detect a format used to reproduce various media files and may encode or decode a media file through a codec appropriate for the relevant format. The resource manager 344 may manage resources, such as a source code, a memory, a storage space, and/or the like of at least one of the applications 370.

The power manager 345 may operate together with a Basic Input/Output System (BIOS), may manage a battery or power, and may provide power information and the like used for an operation. The database manager 346 may manage a database in such a manner as to enable the generation, search and/or change of the database to be used by at least one of the applications 370. The package manager 347 may manage the installation and/or update of an application distributed in the form of a package file.

The connection manager 348 may manage a wireless connectivity such as, for example, Wi-Fi and Bluetooth. The notification manager 349 may display or report, to the user, an event such as an arrival message, an appointment, a proximity alarm, and the like in such a manner as not to disturb the user. The location manager 350 may manage location information of the electronic device. The graphic manager 351 may manage a graphic effect, which is to be provided to the user, and/or a user interface related to the graphic effect. The security manager 352 may provide various security functions used for system security, user authentication, and the like. According to an embodiment of the present disclosure, when the electronic device (e.g., the electronic device 100) has a telephone function, the middleware 330 may further include a telephony manager (not illustrated) for managing a voice telephony call function and/or a video telephony call function of the electronic device.

With continued reference to FIG. 3, the middleware 330 may generate and use a new middleware module through various functional combinations of the above-described internal element modules. The middleware 330 may provide modules specialized according to types of OSs in order to provide differentiated functions. Also, the middleware 330 may dynamically delete some of the existing elements, or may add new elements. Accordingly, the middleware 330 may omit some of the elements described in the various embodiments of the present disclosure, may further include other elements, or may replace the some of the elements with elements, each of which performs a similar function and has a different name.

The API 360 (e.g., the API 133) is a set of API programming functions, and may be provided with a different configuration according to an OS. In the case of Android or iOS, for example, one API set may be provided to each platform. In the case of Tizen, for example, two or more API sets may be provided to each platform.

The applications 370 (e.g., the applications 134) may include, for example, a preloaded application and/or a third party application. The applications 370 (e.g., the applications 134) may include, for example, a home application 371, a dialer application 372, a Short Message Service (SMS)/Multimedia Message Service (MMS) application 373, an Instant Message (IM) application 374, a browser application 375, a camera application 376, an alarm application 377, a contact application 378, a voice dial application 379, an electronic mail (e-mail) application 380, a calendar application 381, a media player application 382, an album application 383, a clock application 384, and any other suitable and/or similar application.

At least a part of the programming module 300 may be implemented by instructions stored in a non-transitory computer-readable storage medium. When the instructions are executed by one or more processors (e.g., the one or more processors 210), the one or more processors may perform functions corresponding to the instructions. The non-transitory computer-readable storage medium may be, for example, the memory 220. At least a part of the programming module 300 may be implemented (e.g., executed) by, for example, the one or more processors 210. At least a part of the programming module 300 may include, for example, a module, a program, a routine, a set of instructions, and/or a process for performing one or more functions.

Names of the elements of the programming module (e.g., the programming module 300) according to an embodiment of the present disclosure may change depending on the type of OS. The programming module according to an embodiment of the present disclosure may include one or more of the above-described elements. Alternatively, some of the above-described elements may be omitted from the programming module. Alternatively, the programming module may further include additional elements according to an embodiment of the present disclosure may be processed in a sequential method, a parallel method, a repetitive method, or a heuristic method. Also, some of the operations may be omitted, or other operations may be added to the operations.

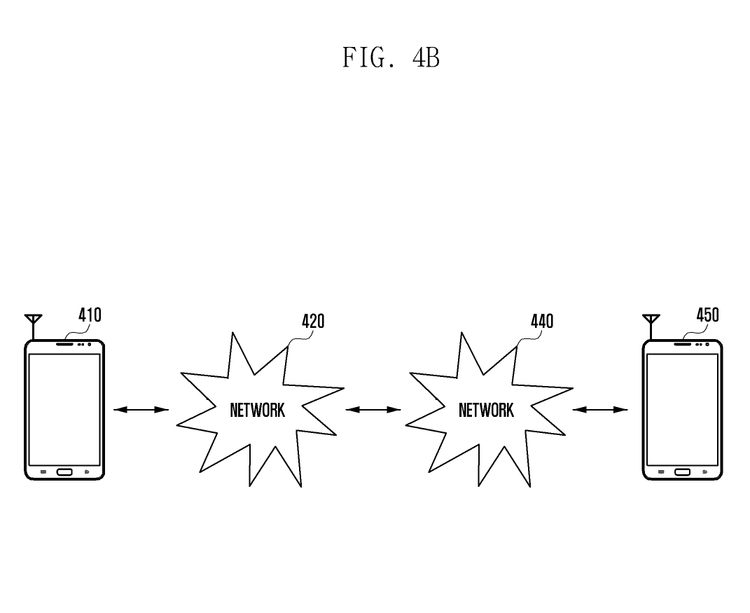

FIGS. 4A and 4B illustrate exchange of messages between electronic devices according to an embodiment of the present disclosure.

In FIGS. 4A and 4B, electronic devices 410 and 450 may correspond to the electronic device described in FIGS. 1 to 3. In the following description, the electronic devices 410 and 450 are assumed to have the same configuration as the electronic device shown in FIG. 1.

First, a brief description is given of the difference between FIG. 4A and FIG. 4B. Whereas messages are exchanged between electronic devices through a message server 430 in FIG. 4A, messages are sent and received by electronic devices connected through a network without traversing a message server in FIG. 4B. Although two networks 420 and 440 are shown in FIG. 4B, the electronic devices 410 and 450 may be interconnected through one network or through two or more networks. A peer to peer arrangement may also be used to permit communication between the two devices.

In one embodiment, the electronic devices 410 and 450 may exchange messages through the networks 420 and 440. For example, message transmission and reception may be performed via the message server 430 as shown in FIG. 4A. The message server 430 may be a server residing on a mobile communication network or a server residing on the Internet.

In another embodiment, an electronic device may support the function of a message server as shown in FIG. 4B. For example, to exchange messages between multiple electronic devices, at least one electronic device may act as a server.

The networks 420 and 440 in FIGS. 4A and 4B may each be a wired network, a wireless network, or a mixed wired/wireless network. In the case of being a wireless network, the networks 420 and 440 may be a mobile communication network such as a 3G network and LTE network. In the case of the networks not being a mobile communication network, the networks 420 and 440 may be, for example, a Wi-Fi network, an ad-hoc network, a Bluetooth network or an NFC network, or a combination thereof. In the case of being a wired network, the networks 420 and 440 may be an intranet, an IP network, a local area network (LAN) or a voice communication network, or a combination thereof.

The message server 430 may deliver at least one of an email message, an SMS message, an MMS message and an instant message. In one embodiment, the message server 430 may provide at least one of the electronic devices 410 and 450 with message status information containing an indication as to whether a sent message has been read.

In one embodiment, electronic devices may send and receive instant messages. For example, the first electronic device 410 may send an instant message, and the second electronic device 450 may receive the instant message sent by the first electronic device 410.

The instant message sent by the first electronic device 410 may be delivered to the second electronic device 450 via the message server 430. Upon reception of a message, the second electronic device 450 may check the reception confirmation state of the received message. The reception confirmation state of a received message may be either “read” or “unread”.

In one embodiment, a received message may be in the read state or in the unread state. For example, a received message may be initially in the unread state. When a message in the unread state is read or viewed by the user, the state of the message may be changed from the unread state to the read state. Whether a received message is read by the user may be determined on the basis of user input to display contents of the received message. The “opening” of a message, in which it is displayed for a user, can be considered as being viewed or read. It is also possible to utilize some indication by the user to mark the message as having been read. This indication may occur by touching or clicking some area of the message or adjacent thereto as directed to acknowledge reading the message.

In addition, when a menu item for changing the state of a received message to the read state is selected, the received message may be placed in the read state.

When the reception confirmation state of a received message is changed, the second electronic device 450 may send reception confirmation information to the message server 430. For example, the second electronic device 450 may notify the message server 430 of reading of the instant message. Accordingly, the message server 430 may provide the first electronic device 410 with information indicating whether the instant message is read.

As shown in FIG. 4B, when no message server is involved, the electronic devices 410 and 450 may exchange a message and reception confirmation state information for the message through the networks 420 and 440. For example, the first electronic device 410 may send an instant message, and the second electronic device 450 may receive the instant message through the networks 420 and 440. When the reception confirmation state of a received message is changed, the second electronic device 450 may directly notify the first electronic device 410 of the reception confirmation state change of the received message through the networks 420 and 440.

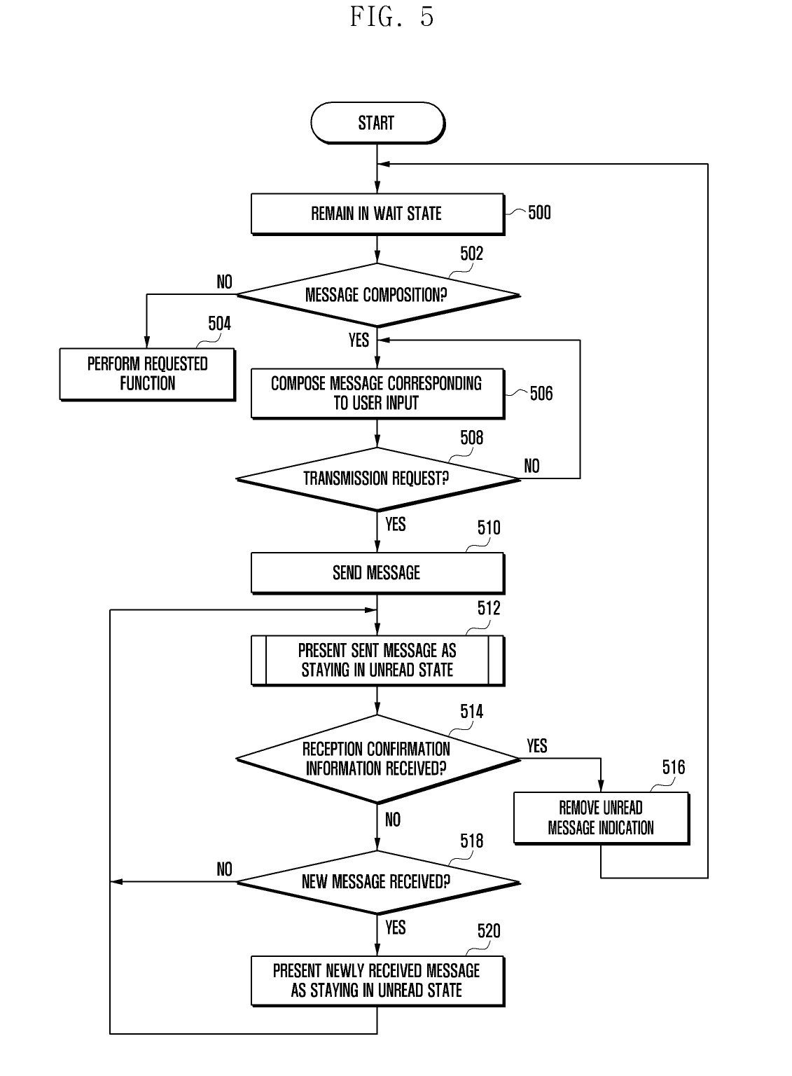

FIG. 5 is a flowchart of a procedure for sending and receiving messages in an electronic device according to an embodiment of the present disclosure. For ease of description, the electronic device is assumed to have a configuration depicted in FIG. 1. However, it will become apparent to those skilled in the art that the description related to FIG. 5 may also be given on the basis of a configuration identical or similar to that of FIG. 2 or FIG. 3.

At operation 500, the processor 120 of the electronic device remains in the wait state. In the wait state, the processor 120 may be waiting for the occurrence of an event. Here, the event may refer to a placement of a call, a reception of a call, a composition of a message, an arrival of an alarm time, or the like.

At operation 502, the processor 120 checks whether a message composition request is issued. If a message composition request is issued, then operation 506 is performed. If a message composition request is not issued, then operation 504 is then performed at which the processor 120 performs a requested function and then ends the procedure.

At operation 506, the processor 120 composes a message corresponding to information entered through the user input module 140. The user input module 140 may be composed of or connected with a touch pad, or some other type of input device. The touch pad may be placed on a display connected with the electronic device (e.g. electronic device 100).

The processor 120 may control the display module 150 to display a message composition window and display input keys for entering information. When an input key displayed on the display module 150 is touched, the processor 120 may generate a character corresponding to the touched input key and display the character in the message composition window.

At operation 508, the processor 120 checks whether a transmission request for the composed message is issued. If a message transmission request is issued, then operation 510 is performed. If a message transmission request is not issued, the procedure returns to operation 506.

At operation 510, the processor 120 sends the composed message through the communication module 160.

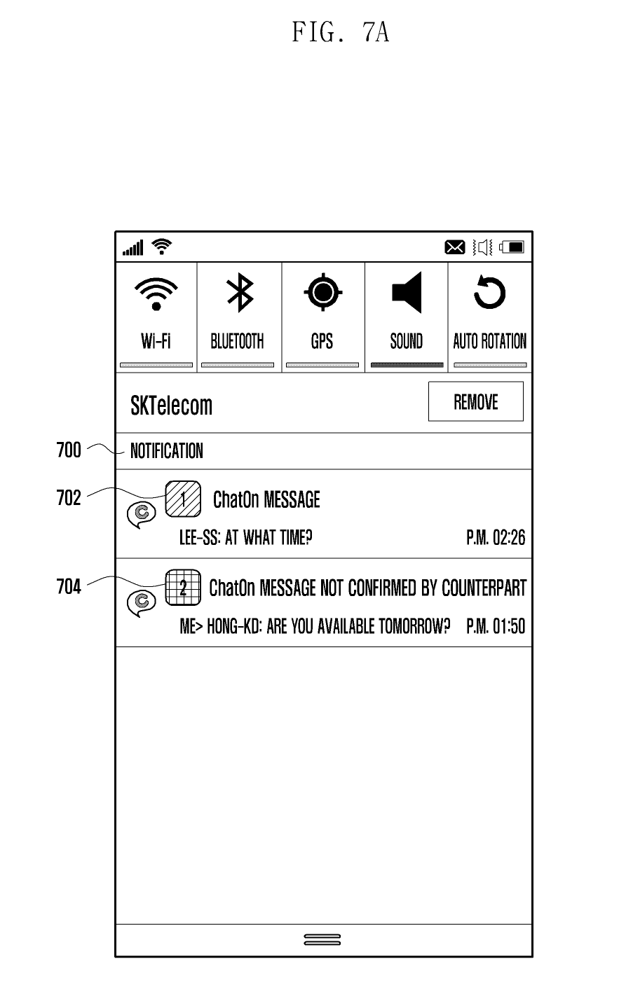

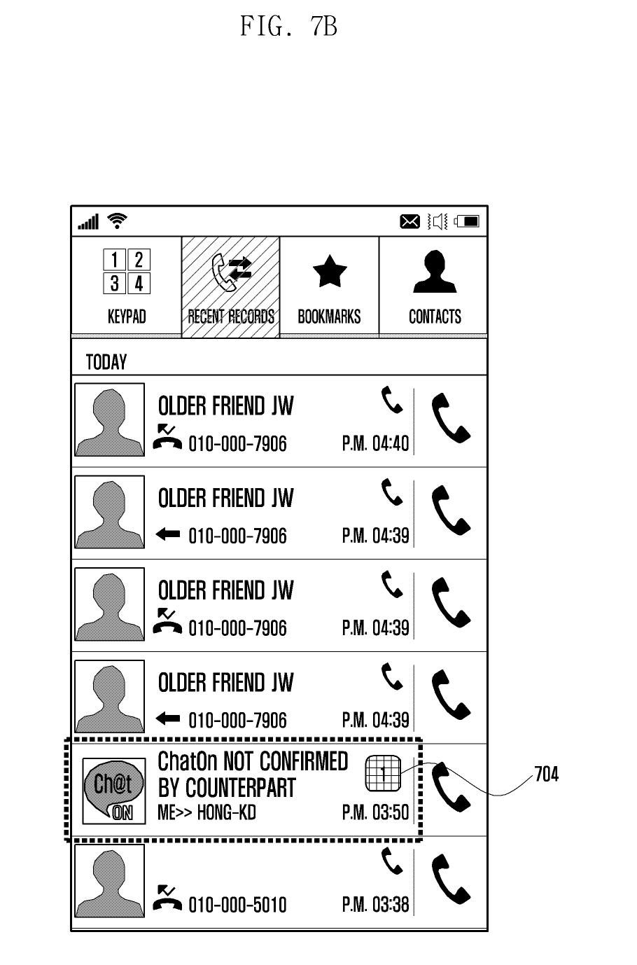

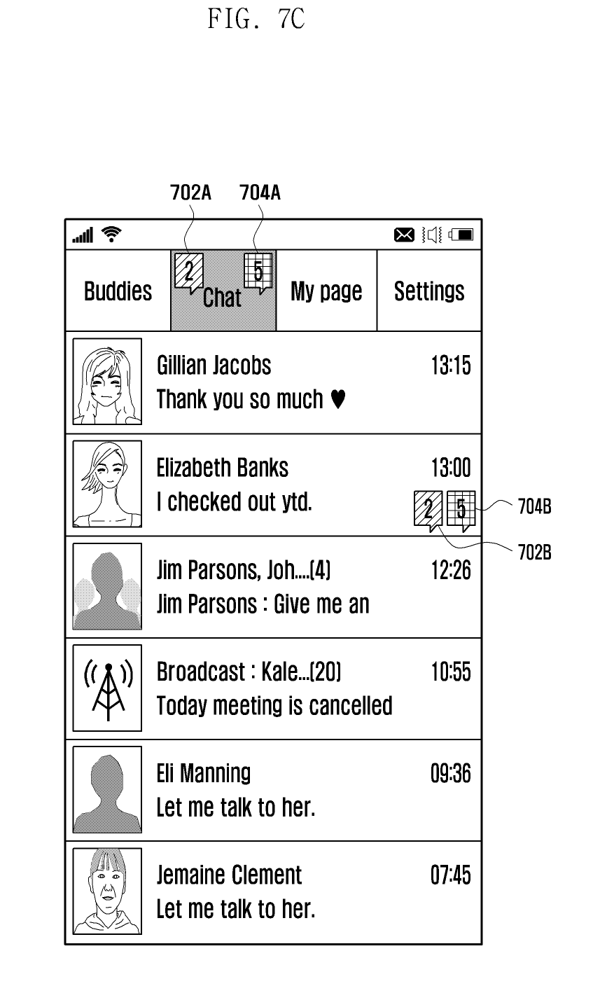

At operation 512, the processor 120 may control the display module 150 to display the sent message and status thereof. Here, the status of a sent message may be displayed when a status display window or history window of the electronic device is invoked or when a status display window of an application program is invoked. For example, a sent message may be initially displayed as remaining in the unread state. Display of sent messages in the unread state is described in more detail with reference to FIGS. 7A to 7C.

FIGS. 7A to 7C are screen representations illustrating display of messages unread by a counterpart user among messages sent by the electronic device according to various embodiments of the present disclosure.

In FIG. 7A, notifications are displayed together with settings in a status display window of the electronic device (e.g., electronic device 410). According to embodiments, the status display window may include various types of information and may be presented in various forms. The status display window of the electronic device may include an unread received message notification window 702 and an unread sent message notification window 704, which are described below.

For example, as shown in FIG. 7A, a notification window 700 may include an unread received message notification window 702 indicating a message unread by the user among messages sent by counterpart users, and an unread sent message notification window 704 indicating a message unread by a counterpart user among messages sent by the user. It is possible to configure the unread received message notification window 702 and the unread sent message notification window 704 to be intuitively distinguished by using different colors, different brightness levels or different icons, different sizes, different shapes, flashing at different intervals or one flashing and the other not flashing, etc. In other words, some visually distinguishing characteristic can be used.

In FIG. 7B, the unread sent message notification window 704 is displayed in a communication history window of the electronic device (e.g. electronic device 410). Here, a call history is shown as an example of a device usage history. The unread sent message notification window 704 may be displayed as the first entry of the communication history or displayed as an entry arranged in reverse chronological order as shown in FIG. 7B. It is also possible to configure the unread received message notification window 702 and the unread sent message notification window 704 to be intuitively distinguished by using different colors, different brightness levels, different icons, different sizes, different shapes, different flashing intervals, etc. The unread sent message notification window 704 may be displayed in an identical or similar manner when the device usage history is a login history for specific application programs.

FIG. 7C illustrates the unread sent message notification window and the unread received message notification window displayed in a list of chat messages sent by an application program. For example, the unread received message notification window may be displayed in a region associated with a messaging application program as indicated by indicia 702A. As another example, the unread received message notification window may be displayed in a chat window containing the corresponding message in the list of chat messages as indicated by indicia 702B.

In addition, for example, the unread sent message notification window may be displayed in a region associated with a messaging application program as indicated by indicia 704A. As another example, the unread sent message notification window may be displayed in a chat window containing the corresponding message in the list of chat messages as indicated by indicia 704B. Other regions for display may also be used.

In one embodiment, as shown in FIGS. 7A to 7C, the number of unread messages from among received messages may be displayed in the unread received message notification window 702. Similarly, the number of unread messages among sent messages may be displayed in the unread sent message notification window 704. For example, in FIGS. 7A to 7C, the numbers shown in the unread received message notification window 702 and unread sent message notification window 704 may indicate the quantity of unread messages.

In FIG. 7C, status windows for a group of chatting related application programs are displayed as examples of an application status window. Although a group of chatting related application programs only are handled in FIG. 7C, when two or more application programs are present in a given folder and at least one of the application programs is a chat or messaging program, the state of unread messages from among sent messages may be displayed in a manner identical to or similar to that shown in FIG. 7C.

Referring back to FIG. 5, at operation 514, the processor 120 checks whether reception confirmation information is received. Here, the reception confirmation information may contain an indication as to whether a sent message is read or unread by the counterpart user.

For example, in FIG. 4A, when the electronic device 450 receives a message and the user thereof reads the received message, the electronic device 450 may send reception confirmation information to the message server 430, which may then forward the reception confirmation information to the electronic device 410 having sent the message. As another example, in FIG. 4B where no message server is employed, when the second electronic device 450 receives a message and the user thereof reads the received message, the second electronic device 450 may send reception confirmation information to the first electronic device 410 having sent the message through the networks 420 and 440.

Operation 514 may be described in more detail as follows. In the case of FIG. 4A, when the electronic device 450 receives a message and the user thereof reads the received message, the electronic device 450 may generate reception confirmation information and send the same to the message server 430. The confirmation information may be automatically generated, or generated in response to a prompt, or via a user changeable setting. Then, the message server 430 may forward the reception confirmation information to the electronic device 410. Hence, in this case, at operation 514, the electronic device 410 having sent a message may check whether reception confirmation information is received from the message server 430.

In the case of FIG. 4B, when the electronic device 450 receives a message and the user thereof reads the received message, the electronic device 450 may generate reception confirmation information and send the same to the electronic device 410 through the networks 420 and 440 (i.e. without a message server as an intermediary). Hence, in this case, at operation 514, the electronic device 410 having sent a message may check whether reception confirmation information is received from the electronic device 450 having received the message.

If reception confirmation information is received at operation 514, then operation 516 is performed at which the processor 120 removes the indication that the sent message is in the unread state and notifies this removal through the display module 150.

Here, at operation 516, an icon indicating presence of an unread message among sent messages may be removed in each of the states illustrated in FIGS. 7A to 7C. Alternatively, when one or more unread messages are present among sent messages, the number of unread messages may be decremented and newly displayed on the display module 150.

For example, in FIG. 7C, the numerical value of ‘5’ shown in the unread sent message notification window 704B indicates presence of five messages unread by the counterpart user (e.g. electronic device 450) among messages sent by the electronic device (e.g. electronic device 410). When at least one of the unread messages is read or confirmed by the counterpart user, the numerical value may be updated. For example, when the counterpart user reads two messages, reception confirmation information for the two messages may be sent to the message server 430, which may then forward the reception confirmation information to the electronic device having sent the messages (e.g. electronic device 410). Upon reception of the reception confirmation information, the electronic device 410 may change the numerical value shown in the unread sent message notification window from 5 (currently shown) to 3. In the case of FIG. 4B where no message server is employed, when the counterpart user reads or confirms two of unread messages, reception confirmation information for the two messages may be sent to the electronic device having sent the messages (e.g. electronic device 410) through the networks 420 and 440.

If reception confirmation information is not received at operation 514, then operation 518 is performed at which the processor 120 checks whether a new message is received. Here, the new message may be one of an instant message, an SMS message, an MMS message, and an email message.

If a new message is not received at operation 518, the procedure returns to operation 512. If a new message is received at operation 518, the procedure proceeds to operation 520 at which the processor 120 displays an indication that the new message remains in the unread state.

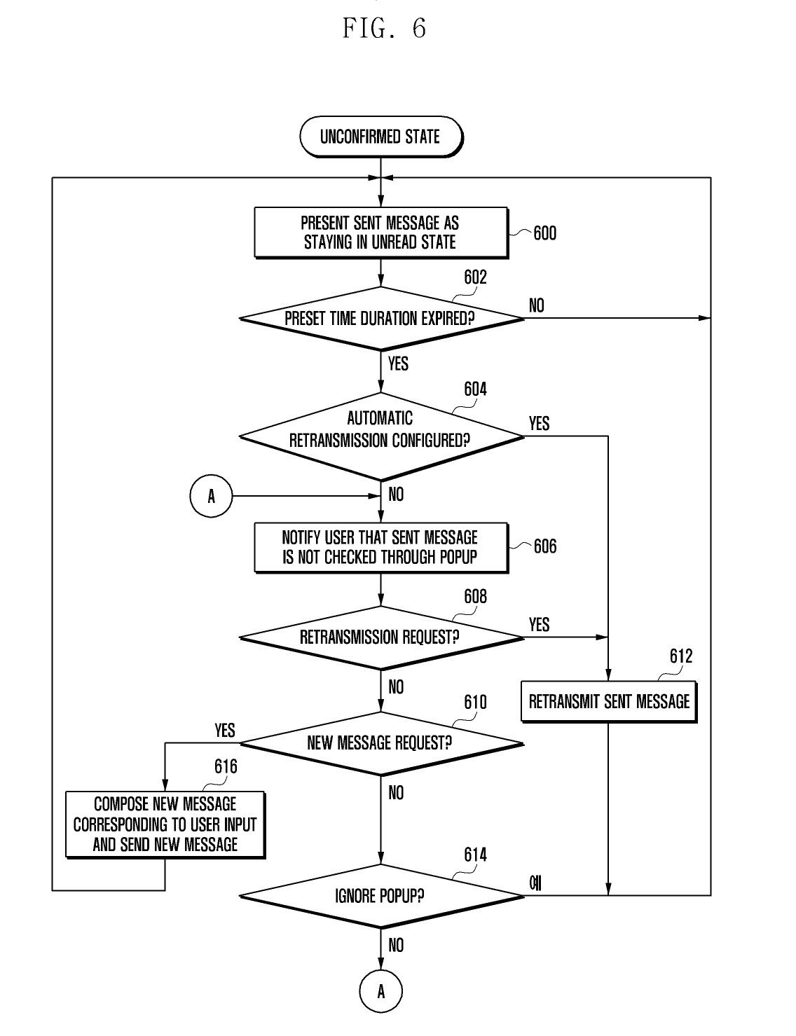

FIG. 6 is a flowchart of an operational procedure for handling the status of a sent message according to an embodiment of the present disclosure. The procedure of FIG. 6 may be performed by, for example, the electronic device 100 shown in FIG. 1.

At operation 600, the processor 120 controls the display module 150 to sustain display of an indication that a sent message remains in the unread state. Here, display of a sent message in the unread state may be performed in a manner described in connection with FIG. 5 and FIGS. 7A to 7C.

At operation 602, the processor 120 checks whether a preset time duration has expired while the sent message stays in the unread state. Here, the time duration may be, for example, there or five minutes. The time duration may be determined by the user, by the manufacturer at the time of manufacture, or by a corresponding message server if present.

In one embodiment, the procedure may be configured so that the subsequent operations are not executed during a given time slot (e.g. from 10 a.m. to 11 a.m. on Monday because of a scheduled meeting) although automatic retransmission is set after expiration of the preset time duration. It is also possible to configure the procedure so that the subsequent operations are not executed during a sleep time preset by the user. The procedure of FIG. 6 may be not executed when the user configures settings so that automatic retransmission is not examined on a holiday or weekend. It is also possible to configure settings so that the procedure of FIG. 6 is not executed when the electronic device is in a power saving mode, when the electronic device is a portable terminal, or when the remaining battery power is low or insufficient.

The procedure of FIG. 6 may be selectively applied to particular users and/or a group of users. In other words, it is possible to configure settings in advance so that the procedure of FIG. 6 is executed on a user basis or on a group basis. For example, it is possible to configure settings in advance so that the procedure of FIG. 6 is executed or not executed for individual users “Hong KD”, “Kim CS” and “Hong YH”. In addition, user groups such as “friend group”, “family group” and “business group” may be formed and selected. It is also possible to configure settings in advance so that the procedure of FIG. 6 is executed or not executed for a selected group.

It is possible for the user to configure settings so that the procedure of FIG. 6 is not executed in various other cases as desired. As described above, the determination whether to execute the procedure of FIG. 6 may be made in advance according to preset information. In the following description, it is assumed that determination has been made in advance to execute the procedure of FIG. 6.

For retransmission, the same message may be processed twice by the sender and receiver sides or the message may be re-sent. The message may indicate it is a retransmission, and may include the date and time of the original message. Otherwise, some messages lose relevance or can confuse the recipient if re-sent without any “flagging” of the message to indicate the message was previously sent.

Referring back to FIG. 6, if the preset time duration has expired at operation 602, then operation 604 is performed. If the preset time duration has not expired, then the procedure returns to operation 600.

At operation 604, the processor 120 checks whether automatic retransmission is configured. In other words, when a sent message is not confirmed or read by the counterpart user within a preset time, the message may be automatically re-sent according to settings of the user, manufacturer or message server.

If automatic retransmission is configured at operation 604 (a “Yes”), the procedure then performs operation 612. If automatic retransmission is not configured (a “No”), then procedure operation 606 is performed.

At operation 612, the processor 120 controls the communication module 160 to send the message, which corresponds to a message that is indicated by the display module 150 as not being read by a counterpart user, to the counterpart user. To this end, the processor 120 may save information of sent messages in the memory 130. Later, the processor 120 may retrieve information on a message that is sent to a counterpart user but not confirmed by the counterpart user from the memory 130, and control the communication module 160 to send a needed message to the counterpart user. Accordingly, the user of the counterpart electronic device is prompted to rapidly check a received message.

At operation 606, the processor 120 notifies the user that the sent message is not checked yet by the counterpart user through the display module 150. The unread state of a sent message may be notified to the user through various user interface mechanisms including a popup window, sound, vibration or fragrant smell, or a combination thereof.

For example, the processor 120 may control the display module 150 to display a popup window that contains one or more selection icons indicating “retransmission” for message retransmission, “cancellation” for transmission cancellation, and “ignore” for ignoring the popup window. In addition, the processor 120 may display the sent message or the counterpart user in the popup window on the display module 150.

At operation 608, the processor 120 checks whether a retransmission request is issued through the user input module 140. For example, the “retransmission” icon of the popup window may be selected. If a retransmission request is issued at operation 608, then at operation 612 the message is retransmitted.

If a retransmission request is not issued at operation 608, then operation 610 is performed at which the processor 120 checks whether a new message request is issued through the user input module 140. If a new message request is issued at operation 610, then operation 616 is performed at which the processor 120 creates a new message according to user input from the user input module 140 and controls the communication module 160 to send the new message. Creation and transmission of a new message are described before in connection with FIG. 5.

If a new message request is not issued at operation 610, then operation 614 is performed at which the processor 120 checks whether the “ignore” icon of the popup window is selected through the user input module 140. If the “ignore” icon is selected, the procedure may return to operation 600. If the “ignore” icon is not selected, the procedure may return to operation 606 and sustain display of the popup window.

The apparatuses and methods of the disclosure can be implemented in hardware, and in part as firmware or as software or computer code in conjunction with hardware that is stored on a non-transitory machine readable medium such as a CD ROM, a RAM, a floppy disk, a hard disk, or a magneto-optical disk, or computer code downloaded over a network originally stored on a remote recording medium or a non-transitory machine readable medium and stored on a local non-transitory recording medium for execution by hardware such as a processor, so that the methods described herein are loaded into hardware such as a general purpose computer, or a special processor or in programmable or dedicated hardware, such as an ASIC or FPGA. As would be understood in the art, the computer, the processor, microprocessor, controller, control unit or other programmable hardware include memory components, e.g., RAM, ROM, Flash, etc. that may store or receive software or computer code that when accessed and executed by the computer, processor or hardware implement the processing methods described herein. In addition, it would be recognized that when a general purpose computer accesses code for implementing the processing shown herein, the execution of the code transforms the general purpose computer into a special purpose computer for executing the processing shown herein. In addition, an artisan understands and appreciates that a “processor”, “microprocessor” “controller”, or “control unit” or “microcontroller” constitute hardware in the claimed disclosure that contain circuitry that is configured for operation with software or firmware. Under the broadest reasonable interpretation, the appended claims constitute statutory subject matter in compliance with 35 U.S.C. §101.

The definition of the terms “unit” or “module” as referred to herein is to be understood as constituting hardware circuitry such as a processor or

microprocessor configured for a certain desired functionality, or a communication module containing hardware such as transmitter, receiver or transceiver, or a non-transitory medium comprising machine executable code that is loaded into and executed by hardware for operation, in accordance
with statutory subject matter under 35 U.S.C. §101 and does not constitute software per se or pure software.

Hereinabove, various embodiments of the present disclosure are described on the basis of instant messages. However, it will be apparent to those skilled in the art that the embodiments of the present disclosure may also be described on the basis of email messages, SMS messages and/or MMS messages.

What is claimed is:

1. A method for checking a status of a message in an electronic device, the method comprising:
setting a reception confirmation state to “unread” when a message is sent; and
displaying a notification that presents a status of the sent message as being unread based on the setting of the reception confirmation state.

2. The method of claim 1, wherein the notification is displayed in at least one of a status display area of the electronic device, a status display area of an application program and a usage history area of the electronic device.

3. The method of claim 1, further comprising changing the reception confirmation state of the sent message to “read” and displaying the sent message as being read, when reception confirmation information for the sent message indicating the sent message has been read is received.

4. The method of claim 3, further comprising removing the notification when there is no sent message whose reception confirmation state is set to “unread” as a result of changing the reception confirmation state.

5. The method of claim 1, further comprising:
determining a presence of another sent message having a same address as the sent message and setting a reception confirmation state of said another sent message to “unread”; and
displaying a quantity of sent messages having respective reception confirmation states set to “unread” together with an “unread” state indication” in at least one of a status display area of the electronic device, a status display area of an application program and a usage history area of the electronic device.

6. The method of claim 1, further comprising notifying a user that the sent message is unread, when reception confirmation information is not received within a preset time after sending a message to a counterpart electronic device.

7. The method of claim 6, wherein notifying a user that the sent message is unread is performed using one or more of a popup notification, a sound, a vibration, and a fragrant smell.

8. The method of claim 6, wherein notifying a user that the sent message is unread is performed when a preset condition is satisfied.

9. The method of claim 8, wherein the preset condition is satisfied when a current time belongs to a given time slot during which an unread message notification is allowed, or when a recipient user of a sent message is registered for unread message notification or belongs to a group registered for unread message notification.

10. The method of claim 1, wherein the message is one of an instant message, an SMS message, an MMS message and an email message.

11. The method of claim 1, further comprising automatically retransmitting the sent message, when reception confirmation information is not received within a preset time after sending a message to a counterpart electronic device.

12. The method of claim 10, wherein the message being automatically retransmitted contains a retransmission indication.

13. An electronic device supporting message status checking, comprising:
a communication module configured to communicate with another electronic device;
a display module configured to display a message while being composed and to notify of a sent message in the “unread” state;
a memory module configured to store sent messages, received messages, and communication histories;
a user input module configured to generate an input signal corresponding to a user input; and
a processor configured to control a process of setting a reception confirmation state of the sent message to “unread”, when a message is sent, and displaying a notification.

14. The electronic device of claim 13, wherein the notification is displayed in at least one area displayed on the display module among a status display area of the electronic device, a status display area of an application program and a usage history area of the electronic device so as to present at least one sent message whose reception confirmation state is set to “unread” as being unread.

15. The electronic device of claim 13, wherein, in response to reception confirmation information for a sent message is received through the communication module, the processor changes the reception confirmation state of the sent message to “read” and controls the display module to remove the notification.

16. The electronic device of claim 13, wherein, when the reception confirmation state of a sent message is set to “unread”, the processor determines presence of another sent message having a same address as the sent message and having a reception confirmation state is set to “unread”, and displays a quantity of sent messages having respective reception confirmation states set to “unread” together with an “unread” state indication
for a sent message whose reception confirmation state is set to “unread” at the time of displaying at least one of a status display area of the electronic device, a status display area of an application program and a usage history area of the electronic device on the display module.

17. The electronic device of claim 13, wherein, when reception confirmation information is not received within a preset time after sending a message to a
counterpart electronic device, the processor notifies a user that the sent message is unread.

18. The electronic device of claim 17, wherein the processor is allowed to notify the user that the sent message is unread when a current time belongs to a given time slot during which unread message notification is allowed, or when a recipient user of the sent message is registered for unread message notification or belongs to a group registered for unread message notification.

19. The electronic device of claim 13, wherein the sent message is one of an instant message, an SMS message, an MMS message and an email message.

20. The electronic device of claim 13, wherein, when reception confirmation information is not received within a preset time after sending a message to a counterpart electronic device, the processor automatically retransmits the sent message through the communication module.

21. The electronic device of claim 20, wherein, upon automatic retransmission, the processor attaches a retransmission indication to the sent message to be retransmitted.

22. A non-transitory storage medium storing program instructions wherein the program instructions are configured to cause, when executed by at least one processor of an electronic device, the processor to set, when a message is sent by the electronic device to another electronic device, the reception confirmation state of the sent message to “unread”, and to display a notification area in at least one of a status display area of the electronic device, a status display area of an application program and a usage history area of the electronic device so as to present an indication that the sent message whose reception confirmation state is set to “unread” as being unread.
